(19) United States
(12) Patent Application Publication
(10) Pub. No.: US 2005/0271411 A1
(43) Pub. Date: Dec. 8, 2005

(54) Image-forming apparatus that can implement image-forming preparation operation and control method therefor

(75) Inventors: Seiji Shibaki, Ibaraki-ken (JP); Kenji Morita, Ibaraki-ken (JP); Yushi Oka, Chiba-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/146,135

(22) Filed: Jun. 7, 2005

(30) Foreign Application Priority Data
Jun. 7, 2004 (JP) 2004-169090
May 26, 2005 (JP) 2005-154144

(51) Int. Cl. G03G 15/00

(52) U.S. Cl. 399/82

(57) ABSTRACT

In order to reduce a driving time for a scanner motor that rotates the polygon mirror, when it is within a predetermined time period after the power has turned ON or opening/closing of the door has been detected, the driving of the scanner motor is prohibited, even though a print-preparation request created through key operation, opening/closing of the document feeder, setting documents into the document feeder, or the like, is issued; when it is not within a predetermined time period after the power has turned ON or opening/closing of the door has been detected, in order to shorten the first-print time, the scanner motor is driven in response to a print-preparation request.

### FIELD OF THE INVENTION

The present invention relates to an image-forming apparatus that implements image-forming preparation operation prior to an image-forming start command being issued and to a control method therefor.

### DESCRIPTION OF RELATED ART

Conventionally, in an image-forming apparatus that forms images by means of an electrophotographic-method, such as a laser-beam printer, a digital copy machine, and a facsimile machine, in order to shorten a first-print time between instruction of printing and outputting of a print, or a first-copy time between pressing a copy key and outputting of a copy, technologies have been proposed, in which image-forming preparation operation is implemented prior to a print-start instruction or a copy-start instruction being inputted.

For example, in Japanese Patent Laid-Open No. 05-053074 (Prior Art 1), by activating a polygon motor in response to any input through an operation unit, a waiting time until a start is reduced.

Moreover, in Japanese Patent Laid-Open No. 09-107444 (Prior Art 2), by starting the drive of deflecting means in response to an operation related to reading out a document image by reading means, a laser beam is quickly stabilized, thereby reducing a driving time.

Still moreover, in Japanese Patent Laid-Open No. 2000-089621 (Prior Art 3), by starting part of the operation of image-forming means in response to the operation of a key other than a copy start key, a waiting time until an image-forming start is reduced.

Furthermore, in Japanese Patent Laid-Open No. 2001-088403 (Prior Art 4), by implementing print-start preparation in response to reception of a print-preparation start command from a controller, a time until the completion of image-forming is reduced.

Moreover, in Japanese Patent Laid-Open No. 2002-304047 (Prior Art 5), by starting the drive of a polygon motor in response to the setting of setting keys, a first-print time is reduced.

Still moreover, in U.S. Pat. No. 6,282,387 (Prior Art 6), by comparing the discharging time of a finisher with the start-up operation time for image-forming and by optimizing the timing when image-forming operation is started, provision is made for means that prevents the deterioration of consumables.

Furthermore, in Japanese Patent Laid-Open No. 10-326070 (Prior Art 7), provision is made for means in which, by detecting temperatures at two positions, of the heat roller of a fixing device, which give a maximal and a minimal temperature, the timing of activating a scanner motor is selected in printing, according to the temperature difference between the two positions.

Moreover, in U.S. Pat. No. 5,521,686 (Prior Art 8), in the situation that the temperature control of a fixing device is halted, by driving a scanner motor concurrently with the start of print operation, the temperature of the fixing device is controlled in such a way as to be a temperature for printing.

However, in the prior arts described above, even in the situation that, in fact, the user can not immediately make a print or a copy, for example, when the door of an image-forming apparatus is opened or closed, or when the power is turned ON, a control unit issues an instruction of an image-forming preparation operation to a printing engine, thereby starting part of operation of a polygon motor (a scanner motor), deflecting means, or image-forming means, or starting print-start preparation. Accordingly, the driving time for the polygon motor is prolonged, whereby the lifetime of the polygon motor is likely to be shortened.

In addition, in a current image-forming apparatus, it has become common that the scanner reader unit, the operation unit, the printer unit, and the like are developed as independent units, whereby it has become difficult for the printer unit, which forms images, to keep track of operation of the operation unit and the scanner reader unit; therefore, as described in the foregoing Prior Arts 1 to 3, and 5, a dedicated interface that detects an operation related to reading out a document image through an operation unit or reading means, an operation of a key other than a copy-start key, and setting of a key is required, whereby the cost of the image-forming apparatus may be raised.

Moreover, as is the case with Prior Art 4, even in the situation that, in fact, the user can not immediately make a print or a copy, for example, immediately after the door of an image-forming apparatus is opened or closed, or immediately after the power is turned ON, print-start preparation operation is implemented in response to reception of a print-preparation start command; therefore, the driving time for the polygon motor (scanner motor) is prolonged, whereby the lifetime of the polygon motor is likely to be shortened.

Still moreover, in Prior Art 6, in a system equipped with no finisher and in an operation mode in which no finishing is implemented even though a system is equipped with a finisher, the optimization of a driving time for a laser scanner motor is not achieved.

Furthermore, in Prior Art 7, when a waiting time has become long, the temperature difference does not occur any longer; in this situation, the scanner motor is controlled eventually for a predetermined time period, whereby the optimization of the driving time for the scanner motor is not achieved.

Still furthermore, in Prior Art 8, if a scanner motor whose start-up time is short is used, the rotation of the scanner motor first stabilizes, whereby the optimization of the driving time for the scanner motor is not achieved.

In the case where the lifetime of a polygon motor is long, the foregoing disadvantages are not so crucial problems; however, they bring about the cost hike of an apparatus.

### SUMMARY OF THE INVENTION

The present invention has been made in order to solve the foregoing problems; it is an object of the present invention to provide an image-forming apparatus and a control method therefor that satisfy both the prolonging of the lifetime of a scanner motor and the shortening of the first-print time.

In addition, it is another object of the present invention to provide an image-forming apparatus and a control method therefor that can control the implementation of image-forming preparation operation, based on the state of the apparatus, even though an image-forming preparation operation request is issued by a control unit.

According to the present invention, the foregoing object is attained by providing a method of controlling an image-forming apparatus, comprising: a determining step of determining whether or not an instruction for an image-forming that differs from an image-forming start instruction is carried out; an image-forming preparation request generating step of generating an image-forming preparation request, when it is determined in the determining step that the instruction is carried out; a preparation-operation implementing step of implementing preparation operation in response to occurrence of the preparation request; a door opening/closing detecting step of detecting opening/closing of a door of the image-forming apparatus; and a controlling step of prohibiting the preparation operation from being implemented, when the preparation request occurs within a predetermined time period after it has been detected in the door opening/closing detecting step that the door, which had been opened, has been closed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a side cross-sectional view illustrating the configuration of a digital copy machine according to the First Embodiment;

FIG. 2 is a block diagram showing the configuration of a control system according to the First Embodiment;

FIG. 3 is a view illustrating an example of the configuration of an operation panel 60 according to the First Embodiment;

FIG. 4 is a flowchart showing scanner-driving control according to the First Embodiment;

FIG. 5 is a flowchart showing processes according to the First Embodiment, for determining whether or not print-preparation should be implemented;

FIG. 6 is a flowchart showing scanner-driving control and fixing control according to the Second Embodiment; and

FIG. 7 is a view illustrating an example of the configuration of a fixing waiting time according to the Second Embodiment.

### DETAILED DESCRIPTION OF THE PREFERRED EMBODIMENTS

Hereinafter, preferred embodiments of the present invention will be discussed in detail, referring to the accompanying drawings. In these embodiments, an electrophotographic-method digital copy machine will be explained as an example of an image-forming apparatus; however, the present invention is not limited to these embodiments, but can also be applied, for example, to a laser-beam printer, a facsimile machine, or a composite apparatus having a plurality of functions such as a printing function, a printing function, a facsimile function, and the like.

### First Embodiment

In the First Embodiment, in the case where a printer that is in a state of being not able to immediately implementing an image forming process, such as when the door of a copy machine is opened or closed, or the power is turned ON, is instructed to start preparation for copying or printing, a scanner motor is controlled not to be activated.

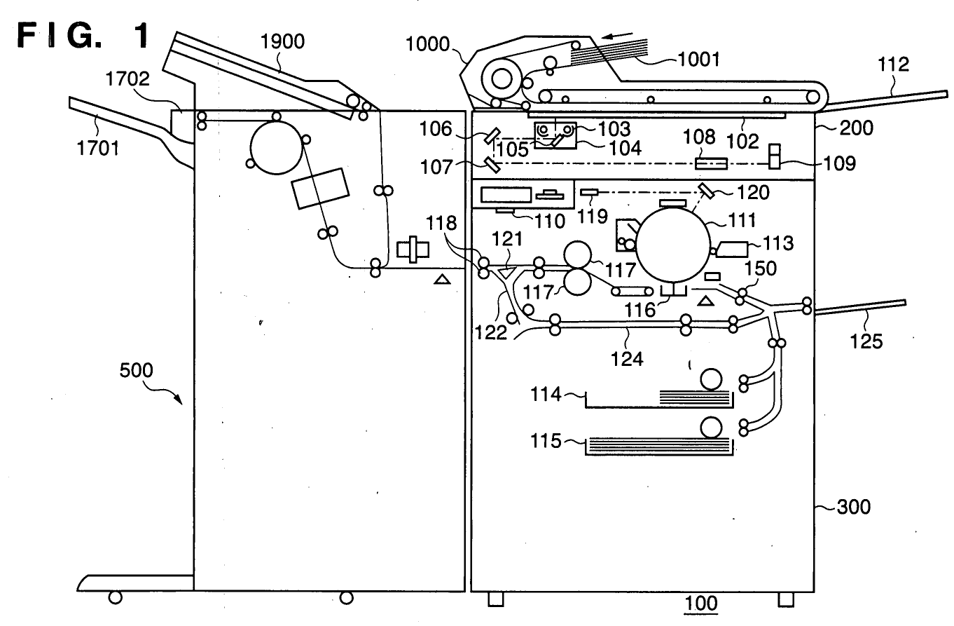

In the first place, with reference to FIG. 1, the structure and operation of a digital copy machine according to the First Embodiment will be described in detail.

FIG. 1 is a side cross-sectional view illustrating the configuration of a digital copy machine according to the First Embodiment. As illustrated in FIG. 1, a digital copy machine 100 as an image-forming apparatus comprises a document feeder 1000, an image reader 200, a printer 300, and a finisher main body 500.

Describing in detail the configuration illustrated in FIG. 1 along with its operation, the document feeder 1000 conveys, by way of a bent path, documents set in a tray 1001, one after another in the order of pages, from left to right on a platen glass 102, and then discharges them onto a paper output tray 112. In this situation, a leader/scanner unit 104 is fixed at a predetermined position; the documents are read out while passing from left to right on the reader/scanner 104. When a document passes on the reader/scanner 104, the light of a lamp 103 inside the leader/scanner unit 104 is illuminated onto the document; the reflected light from the document is led to an image sensor 109 by way of mirrors 105, 106, and 107, and by way of a lens 108.

In addition, by conveying through the document feeder 1000 a document on the platen glass 102 to a predetermined position and then halting the document, and by shifting the leader/scanner unit 104 from left to right, the document may also be read out.

Additionally, the document feeder 1000 is constituted in such a way as to be possible opening and closing to the platen glass 102; the opening and closing of the document feeder 1000 is detected by a predetermined sensor; the opening/closing state of the document feeder 1000 is notified from a reader unit described later to a control unit. Moreover, in the document feeder 1000, it is detected that a document has been set in a tray 1001 by an unillustrated sensor, and the detected state is notified from the reader unit to the control unit.

In this situation, image data of the document, read out by the image sensor 109, is image-processed and sent to an exposure controller 110 of the printer 300. The exposure controller 110 irradiates onto a photoconductive drum 111 by way of a polygon 120, a laser beam that is switched ON/OFF based on the image data, thereby forming an electrostatic latent image on the photoconductive drum 111. The electrostatic latent image on the photoconductive drum 111 is developed by a developing device 113; a developer on the photoconductive drum 111 is transferred by a transfer unit 116 onto a sheet that is fed either from a cassette 114, 115, or a manual paper feeding unit 125, or through a both-side conveying path 124 and that is timed by a resist roller 150.

The sheet onto which the developer has been transferred undergoes in a fixing unit 117 developer-fixing processing through heat and pressure. The sheet that has passed through the fixing unit 117 is temporarily led by a flapper 121 to a path 122; after the rear end of the sheet has passed through the flapper 121, the sheet is made to switchback and then is led by the flapper 121 to discharging rollers 118. Accordingly, the sheet is discharged by the discharging rollers 118 from the printer 300, with its surface onto which the developer has been transferred facing downward (face-down).

In the case where an image is formed on a hard sheet, such as an OHP sheet, fed through the manual paper feeding unit 125, the sheet is not led to the path 122, but is discharged through the discharging rollers 118, with the surface onto which the developer has been transferred facing upward (face-up).

In addition, in the case where images are formed on both surfaces of a sheet, the sheet is directly led from the fixing unit 117 to the discharging rollers 118; immediately after the rear end of the sheet has passed through the flapper 121, the sheet is made to switchback and then is led by the flapper 121 to the both-side conveying path 124.

Thereafter, the sheet that has been discharged through the discharging rollers 118 is conveyed to the finisher main body 500. In the finisher main body 500, various types of processing, such as shift processing (offset discharge), binding processing, and punching, are applied to the sheet. A inserter 1900 is provided on the finisher main body 500, thereby enabling cover sheets, slip sheets, and the like to be conveyed to the finisher main body 500, and then to be inserted into the sheets discharged through the discharging rollers 118. In the case of outputting a set of sheets being shifted from another set of sheets, e.g., in the case of shifted sorting, a matching plate 1702 shifts in a direction perpendicular to the conveyance direction, thereby discharging sheets at the rear or front position on a tray 1701.

It is assumed that the copy machine 100 is connected through a network, for example, to an external apparatus, such as a personal computer, and has a printing function of printing image data, according to a printing assignment sent from the external apparatus.

Next, the configuration of a control system will be described in detail, in which independent units, of the copy machine 100 according to the First Embodiment, such as a reader unit, a control unit, and a printer unit, are controlled.

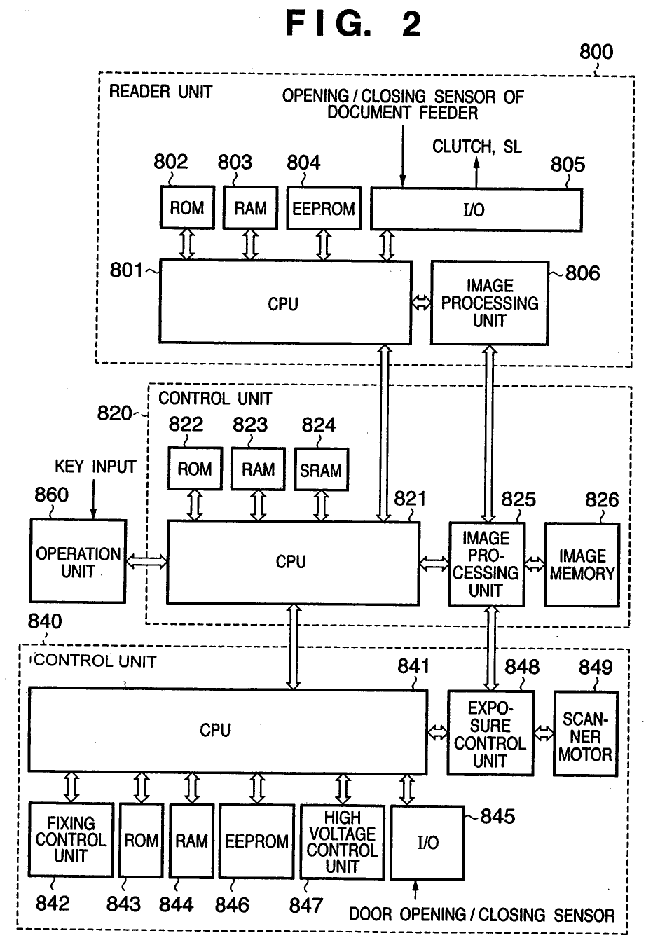

FIG. 2 is a block diagram showing the configuration of a control system according to the First Embodiment. A reader unit 800 shown in FIG. 2 is a unit for controlling the document feeder 1000 and the image reader 200, and mainly implements feeding of documents and reading of images.

In the reader unit 800, the reference number 801 denotes a central processing unit (referred to as CPU, hereinafter) for controlling the entire reader unit 800; the reference number 802 denotes a read only memory (referred to as ROM, hereinafter) that stores control procedures (control programs) for the document feeder 1000 and the image reader 200; the CPU 801 controls each constituent devices of the document feeder 1000 and the image reader 200, according to the control procedures stored in the ROM 802. The reference number 803 denotes a random access memory (referred to RAM, hereinafter), as a main storage, that is utilized as a storage area for storing input data, working, and the like; the reference number 804 denotes an electrically erasable programmable read only memory (referred to EEPROM, hereinafter). The reference number 805 denotes an input/output (referred to as I/O, hereinafter) IC for receiving from the CPU 801 control-signal outputs to loads such as a motor and signals from a sensor and the like, and for sending them to the CPU 801.

The I/O 805 also detects opening or closing of the document feeder 1000; when a predetermined sensor detects the opening or closing of the document feeder, the detected state is notified through serial communication from the CPU 801 of the reader unit 800 to a CPU 821 of a control unit 820. Moreover, when it is detected that a document has been set in the tray 1001 of the document feeder 1000 by a sensor (not shown), the status is notified from the CPU 801 to the CPU 821. The reference number 806 denotes an image processing unit for applying shading correction to image data read through the image sensor (CCD) 109 and for controlling the transmission of the corrected data to a control unit 820 described later.

Meanwhile, the control unit 820 implements the entire control of the copy machine 100, while instructing the reader unit 800 and the printer unit 840. In the control unit 820, the reference number 821 denotes a central processing unit (referred to as CPU, hereinafter) for controlling the entire copy machine 100; the reference number 822 denotes a read only memory (referred to as ROM, hereinafter) that stores control procedures (control programs) for the copy machine 100; the CPU 821 controls each constituent device of the copy machine 100, according to the control procedures stored in the ROM 822. The reference number 823 denotes a random access memory (referred to RAM, hereinafter), as a main storage, that is utilized as a storage area for storing input data, working, and the like. The CPU 821 receives inputs from the various keys of an operation unit 860, through a bus and a suitable I/O (not shown), and further makes necessary information to be displayed on a display on the panel of the operation unit 860.

The reference number 824 denotes a memory (SRAM) for holding data such as adjustment values, which is required to be held even after the main power is turned OFF, the total number of prints, and the like; the memory 824 backs up data, with a battery (not shown) being connected thereto. The reference number 825 denotes an image processing unit for processing image data transmitted from the reader unit 800, or, through a network (not shown), from an external apparatus such as a personal computer, and implements processing such as changing zoom ratio, compressing image data, and decompressing. In addition, the image processing unit 825 transmits to a printer unit 840 described later image data to be printed. The reference number 826 denotes an image memory that is utilized when the image processing unit 825 implements a predetermined image processing.

When receiving from the CPU 801 of the reader unit 800 notification of change of a state due to opening or closing of the document feeder 1000, when a document is set into the document feeder 1000, and when receiving from the operation unit 860 an operational input related to copying (such as mode setting and releasing of the sleep state (energy-saving state)), it can be anticipated that the user will use the copy machine from now; therefore, the CPU 821 of the control unit 820 notifies a CPU 841 of a printer unit 840 of a print-preparation request.

In addition, it is assumed that the control system is constituted in such a way that the copy machine 100 is connected through a network to an external apparatus, also when the copy machine 100 receives a printing assignment from the external apparatus, the print-preparation request is notified to the CPU 841 of the printer unit 840 prior to the issue of a print-start instruction.

The printer unit 840 is a unit for controlling the printer 300, and mainly implements conveyance control, high voltage control, fixing control, laser control, and the like. The CPU 841 is a central processing unit (referred to as CPU, hereinafter) for controlling the entire printer unit 840; the reference number 843 denotes a read only memory (referred to as ROM, hereinafter) that stores control procedures (control programs) for the printer 300; the CPU 841 controls each constituent device of the printer 300, according to the control procedures stored in the ROM 843. The reference number 844 denotes a random access memory (referred to RAM, hereinafter), as a main storage, that is utilized as a storage area for storing input data, working, and the like.

The reference number 845 denotes an input/output (referred to as I/O, hereinafter) IC for receiving from the CPU 841 control-signal outputs to loads such as a motor and signals from a sensor and the like, and for sending them to the CPU 841. In the First Embodiment, by inputting to the I/O IC 845 a detection signal from a predetermined sensor that detects opening or closing of the door of the printer, the CPU 841 of the printer unit 840 detects the opening/closing state of the door. When detecting through the I/O IC 845 the opening or closing of the door, the CPU 841 notifies the CPU 821 of the control unit 820 of the detected state, through serial communication.

The reason why the CPU 841 detects the opening/closing state of the door of the printer unit 840 is as follows: in a case where the door is opened or it is immediately after the door is closed, even though instruction for starting copying or printing is issued, image formation can not be implemented; therefore, the CPU 841 controls the printer unit 840 such that the operation of print-preparation is implemented even though, in such a situation, the print-preparation request based on the detection of opening/closing of the document feeder, an input through the operation unit, or the like, is notified.

The reference number 842 denotes a fixing control unit for controlling the fixing processing through heat and pressure by the fixing unit 117; the control is implemented according to instructions from the CPU 841. The reference number 847 denotes a high voltage control unit for outputting a primary charging output for charging the drum, a development bias output for making toner move onto the drum, and a transfer current output for transferring the toner onto a recording medium; the output according to an output level instructed by the CPU 841 is implemented. In addition, the high voltage control unit 847 has an input unit that measures primary charging output current and transfer output current; the measured current values are notified to the CPU 841 where the current values are utilized to correct the outputs.

In the First Embodiment, the measurement of the primary charging current is implemented each time when 1000 sheets have passed, and the measurement of the transfer output current is implemented each time when 1100 sheets have passed.

The reference number 846 denotes an EEPROM that is connected through a signal line to the CPU 841 and that has very general serial inputs/outputs; the EEPROM 846 implements reading and writing of data, instructed through serial commands from the CPU 841. The reference number 848 denotes an exposure controller for playing a role of forming a latent image on the photoconductive drum 111, based on image data received from the image processing unit 825 of the control unit 820; the exposure controller 848 drives a scanner motor 849 for rotating the polygon 120, and a laser beam from the laser luminescence element 119 illustrated in FIG. 1 is irradiated onto the polygon 120. In addition, the polygon 120 is arranged in such a way that the surface of the photoconductive drum 111 can be scanned by a laser beam; the laser beam has output power corresponding to an image data, thereby making potentials on the photoconductive drum 111 differ from each other; accordingly, an latent image is formed.

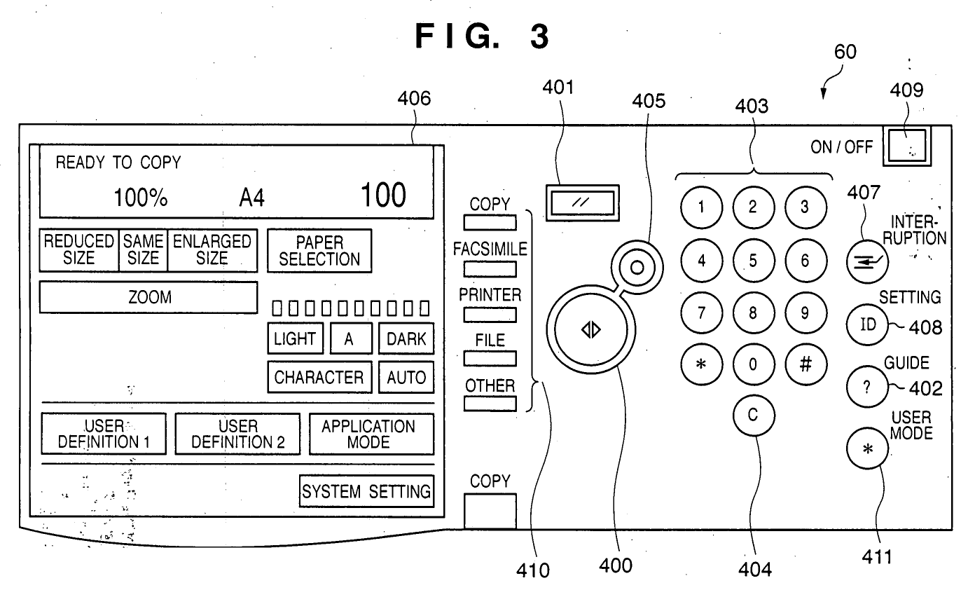

With reference to FIG. 3, the configuration of an operation panel (operation unit 860) provided on the copy machine 100 will be described in detail.

FIG. 3 is a view illustrating an example of the configuration of an operation panel 60 according to the First Embodiment. In FIG. 3, the reference number 400 is a copy start key for instructing the start of copying. The reference number 401 denotes a reset key for returning, to the standard mode, setting conditions in the function being currently selected among the copying function, the facsimile function, the printing function, and the filing function. The reference number 402 denotes a guidance key to be pressed when the guidance function is utilized. The reference number 403 denotes a numeric keypad for inputting values such as a pre-set number of sheets. The reference number 404 denotes a clear key for clearing numerical values. The reference number 405 denotes a stop key for stopping copying during a serial copying.

The reference number 406 denotes a liquid crystal display and a touch panel for displaying setting of various modes, such as the stapling mode, the book-binding mode, or the both-side printing mode, and the state of the printer. The reference number 407 denotes an interruption key for interrupting the copy machine when it is implementing serial copying or being utilized as a facsimile or a printer, and for making an urgent copy. The reference number 408 denotes an identification (ID) key for managing the number of copped sheets for each individual or each division. The reference number 409 denotes a soft switch for turning ON/OFF the power for the copy machine. The reference number 410 denotes function keys to be used when the function of the copy machine is changed. The reference number 411 denotes a user mode key for putting the copy machine into the user mode in which the user preliminarily sets items, e.g., whether the automatic cassette changer is ON or OFF, changing of a pre-set time period for the energy-saving mode, and the like.

The state of key input through the operation panel 60 is communicated to the input port of the CPU 821 so as to be detected by the CPU 821 of the control unit 820.

In the copy machine 100 configured as above, when detecting an key operation, through the operation unit 860, related to copying other than the copy start key 400, or when receiving a printing assignment from an external apparatus, the CPU 821 of the control unit 820 notifies the CPU 841 in the printer unit 840 of a print-preparation request. With regard to the received print-preparation request, the CPU 841 of the printer unit 840 determines whether or not the print-preparation should be implemented, based on the result of detection on the opening/closing state of the door; when a predetermined time period has not elapsed after the door, which had been being opened, is closed, the CPU 841 prevents the scanner motor 849 from being driven. The CPU 841 of the printer unit 840 implements print-preparation operation (driving of the scanner motor), if the CPU 841 receives a print-preparation request when the predetermined time period has elapsed after the door, which had been being opened, is closed. Thereafter, if no printing command is inputted from the control unit 820 within a predetermined time period (for example, ten seconds), the CPU 841 ends the print-preparation operation.

In addition, when the user presses the copy start key 400, the control unit 820 outputs a printing command to the printer unit 840. If the print-preparation operation is not being implemented at the time when the CPU 841 of the printer unit 840 receives the printing command, the CPU 841 immediately makes the scanner motor 849 to be driven for actual printing operation. If the print-preparation operation is being implemented at the time when the CPU 841 of the printer unit 840 receives the printing command, the CPU 841 keeps the scanner motor 849 driven.

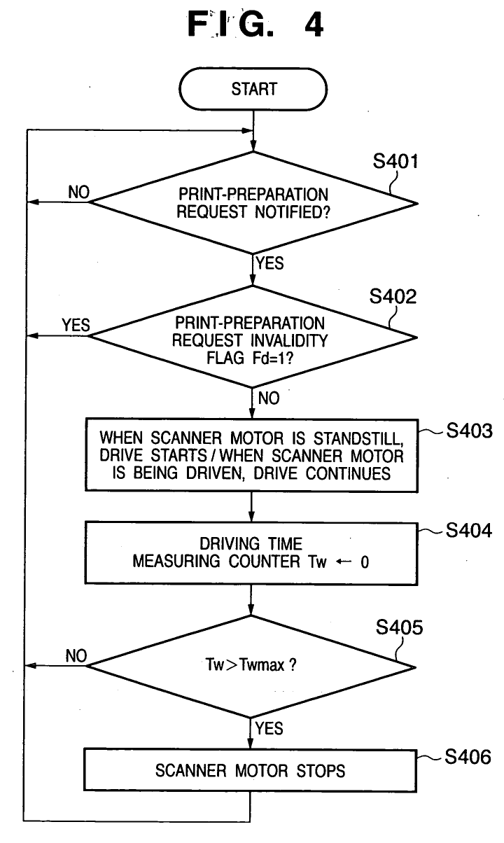

FIG. 4 is a flowchart showing scanner-driving control according to the First Embodiment. This control system is to control driving of the scanner motor 849, by controlling the exposure controller 848 by the CPU 841 of the printer unit 840, according to the control programs stored in the ROM 843. In addition, it is assumed that this control is implemented when a copying assignment through the copy start key or a printing assignment from an external apparatus is not being carried out, and that, when the print-preparation has been carries out and an actual image-forming process has been started, this control is interrupted, and when the image-forming process has been completed, this control is resumed.

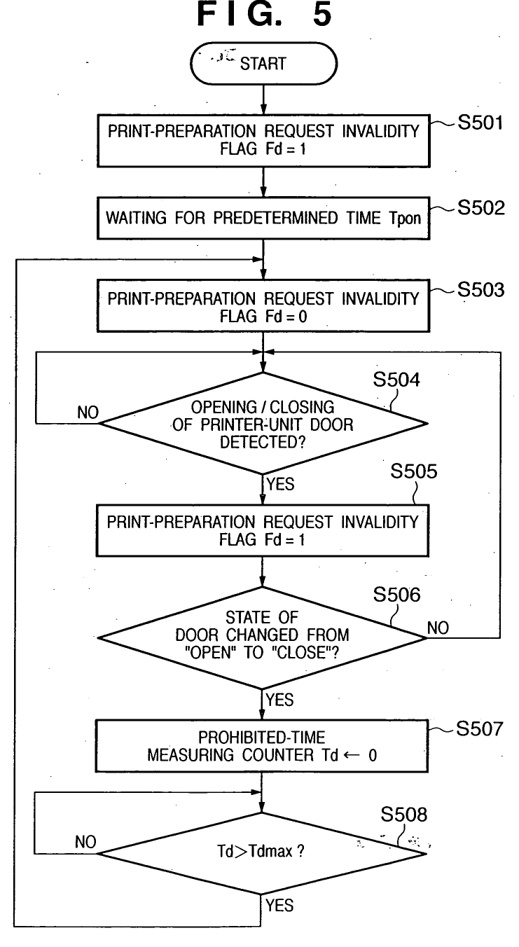

FIG. 5 is a flowchart showing a process according to the First Embodiment, for determining whether or not the print-preparation should be implemented. In this control system, the CPU 841 of the printer unit 840 detects the opening/closing state of the door of the printer unit 840, according to the control programs stored in the ROM 843, sets or resets based on the result of the detection a print-preparation-request invalidity flag Fd, and determines whether or not the print-preparation operation should be implemented.

It is assumed that the two types of control shown in FIGS. 4 and 5 are concurrently and in parallel processed by the CPU 841 of the printer unit 840 after the power is turned ON.

In the step S401 shown in FIG. 4, the CPU 841 waits for a print-preparation request being notified through serial communication from the control unit 820; when the CPU 841 receives the print-preparation request, the step S401 is followed by the step S402. In this situation, as described above, a print-preparation request is issued by the CPU 821 of the control unit 820 when control unit 820 perceives input through operating of a key on the operation unit 860, operation of opening/closing the document feeder 1000, and setting of documents.

In the step S402, a print-preparation-request invalidity flag Fd that is determined to set, through a process in FIG. 5, described later, is referred to. When the flag Fd is being set (Fd=1), the CPU 841 determines that the opening/closing state of the door of the printer unit 840 has been detected, thereby not implementing print-preparation for the print-preparation request, i.e., thereby controlling the scanner motor 849 not to be driven, and then returns to the step S401.

In the step S402, when the print-preparation-request invalidity flag Fd is being reset (Fd=0), the CPU 841 proceeds to the step S403, and then implements print-preparation. Specifically, when the scanner motor 849 is being halted, the CPU 841 controls the exposure controller 848 to start driving; when the scanner motor 849 is already being driven, the CPU 841 controls the exposure controller 848 to maintain the driving conditions.

In the step S404, the CPU 841 initializes the value Tw of a driving-time measuring counter for measuring a driving time for the scanner motor 849 (Tw=0). However, when, in the step S403, the scanner motor 849 is already being driven, the CPU 841 does not initialize the value Tw. The driving-time measuring counter is configured in such a way as to be counted up every one second, by the CPU clock being counted by a hardware counter built in the CPU 841.

In the step S405, the CPU 841 compares the value Tw of the foregoing driving-time measuring counter with a maximal driving time Twmax. When the value Tw of the counter is larger than the maximal driving time Twmax, the CPU 841 proceeds to the step S406. In the step S 406, the CPU 841 determines that, even though the print-preparation operation has been started, the print-start instruction has not been received, i.e., the image-forming process has not been started; and then, the CPU 841 stops the scanner motor 849 and returns to the step S401. When, in the step S405, the value Tw of the counter is not larger than the maximal driving time Twmax, the CPU 841 directly returns to the step S401.

In the First Embodiment, by setting the foregoing maximal driving time Twmax to 10, the scanner motor 849 is driven for 10 seconds.

Meanwhile, after the power is turned On, in the step S501, shown in FIG. 5, that is processed concurrently and in parallel with control in FIG. 4, the CPU 841 sets the foregoing print-preparation-request invalidity flag Fd (Fd=1); in the step S502, the CPU 841 waits for a predetermined time Tpon (seconds), and proceeds to the step S503 after Tpon elapses.

In the First Embodiment, Tpon is set to three seconds. The processes of the steps S501 and S502 are to control the scanner motor 849 not to be driven, by neglecting through the control described in FIG. 4 a print-preparation request, during the duration from the time when the power is turned ON to the time when the predetermined time Tpon elapses, even though the change of a state due to input through operating of a key on the operation unit 860, opening/closing of the document feeder 1000, or setting of documents is notified, and even though the control unit 820 issues the print-preparation request.

In step S503, when Tpon has elapsed after the power is turned ON, the CPU 841 sets print-preparation-request invalidity flag Fd (Fd=0) in order to be able to implement print-preparation upon receiving a print-preparation request from the control unit 820. And then, in the step S504, the CPU 841 detects the change in the state of the printer unit 840, based on a signal, from a door opening/closing sensor of the printer unit 840, that is inputted to the I/O 845. Thereafter, when the change in the door opening/closing state is detected, the CPU 841 proceeds to the step S505 and sets the foregoing print-preparation-request invalidity flag Fd (Fd=1).

In the step S506, the CPU 841 determines whether or not the change, in the state of the door, that has been detected in the step S504 is from “open” to “close”; if such is not the case, the CPU 841 returns to the step S504. If the change is from “open” to “close, the CPU 841 proceeds to the step S507 and initializes the value Td of a prohibited-time measuring counter (Td=0) in order to implement the control in such a way that the print-preparation is not carried out for a predetermined time period even though a print-preparation request is notified. The prohibited-time measuring counter is configured in such a way as to be counted up every one second, by the CPU clock being counted by a hardware counter built in the CPU 841.

In the step S508, the CPU 841 compares the value Td of the foregoing prohibited-time measuring counter with a prohibited time period Tdmax, waits until the value Td of the counter becomes larger than the prohibited time period Tdmax, i.e., until the prohibited time period Tdmax elapses, and returns to the step S503 when the prohibited time period has elapsed.

In the First Embodiment, the foregoing prohibited time period Tdmax is set to three seconds; the control is implemented in such a way that, for three seconds after the state of the door has changed from “open” to “close”, even though a print-preparation request is notified by the control unit 820, the CPU 841 neglects the print-preparation request and does not implement the print-preparation, i.e., the scanner motor 849 is not driven.

In the case where, within Tdmax after the door, which had been opened, has been closed, the copy start key is pressed, or in the case where a print-start instruction is issued, the CPU 841 starts the driving of the scanner motor, in order to start image-forming. However, in the case where it is known that the temperature of the fixing device is low and takes a long time to reach a determined fixing temperature, the driving of the scanner motor may be started in such a way that the timing when the temperature of the fixing device reaches the predetermined temperature approximately coincides with the timing when the speed of the scanner motor reaches a predetermined speed.

As described above, according to the First Embodiment, by prohibiting the scanner motor from being activated through a print-preparation request from the control unit 820, even though inputting is implemented through the operation unit or the like, in the situation that, in fact, the user can not immediately make a print or a copy, for example, when the door of the printer unit is opened or closed, or when the power is turned ON, the total driving time for the scanner motor can be shortened, whereby the lifetime of the scanner motor can be lengthened. In addition, because it is possible to utilize a scanner motor whose lifetime is not so long, the cost reduction of the apparatus can be achieved.

The foregoing step S504 may be a process in which the CPU 841 determines whether or not the state of the door is “open” and proceeds to the step S505 if the state of the door is “open”.

It has become common that, in a current image-forming apparatus, the reader unit, the operation unit, the printer unit, and the like are developed as independent units. It has become difficult for the printer unit, which forms an image, to keep track of operation of the operation unit and the reader unit; however, by prohibiting the scanner motor from being driven, in the situation that, in fact, the user can not immediately make a print or a copy, such as when the door of the printer unit is opened or closed, or when the power is turned ON, even though the image-forming apparatus is configured in such a way as to implements print-start preparation through receiving a print-preparation start command, it is not necessary to provide a dedicated interface for detecting an operation on other units, for example, a key operation, even in the case where the printer unit is independently developed.

### Second Embodiment

Hereinafter, the Second Embodiment according to the present invention will be described in detail, referring to the accompanying drawings. In the Second Embodiment, when a scanner motor having a short start-up time is used, the CPU 841 controls a scanner motor to be activated in such a way that the start-up of the fixing unit is completed approximately at the same time as the start-up of the scanner motor, by, in the case where a key operation is implemented, anticipating the time (referred to as start-up time, hereinafter) that is necessary for the scanner motor to be started up and the start-up time of the fixing unit, even in the case where the scanner motor first starts up and waits for the temperature of the fixing unit being raised.

In other words, in the case where the copy-preparation start or the print-preparation start is instructed in the situation that the scanner motor first starts up and waits for the temperature of the fixing unit being raised, such as when a scanner motor having a short start-up time is used, the control is implemented in such away that the start of activation of the scanner motor is delayed so that the start-up of the scanner motor is completed approximately at the same time as the start-up of the fixing unit.

Also in the Second Embodiment, a digital copy machine will be described as an example of an image-forming apparatus; however, because the configuration of the digital copy machine is the same as that of the First Embodiment that has been explained with reference to FIG. 1, explanation therefor will be omitted.

In addition, the configuration of a control system that controls independent units, such as a reader unit, a control unit, and a printer unit, of the copy machine 100 shown in FIG. 2, is the same as that of the First Embodiment; therefore, explanation therefor will be omitted.

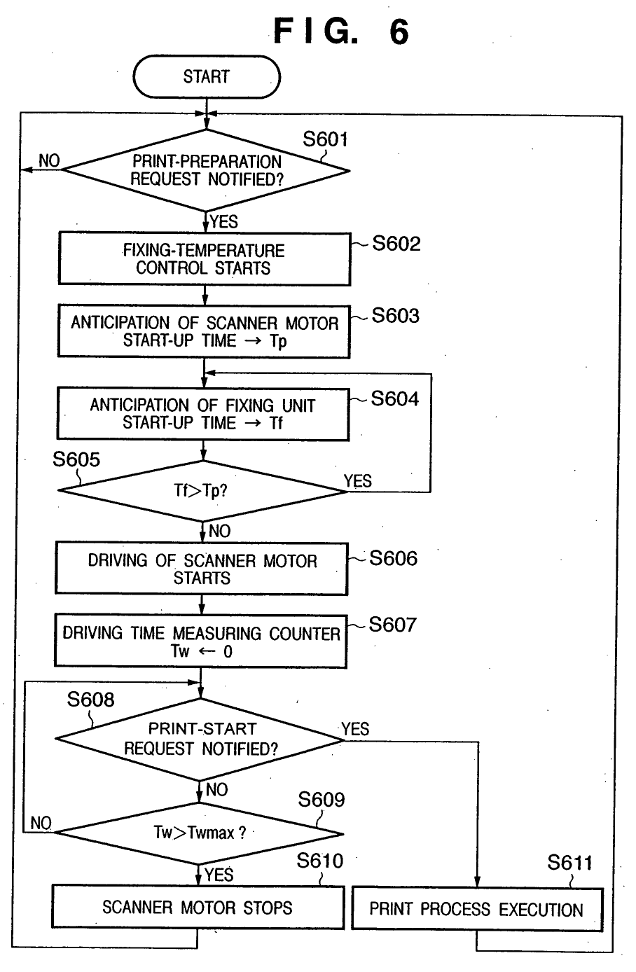

Next, referring to FIG. 6, the starting timing for the driving of the scanner motor 849 and for the fixing control in the fixing control unit 842 will be explained.

FIG. 6 is a flowchart showing scanner-driving control and fixing control according to the Second Embodiment. In this control system, the CPU 841 of the printer unit 840 controls the driving of the scanner motor 849, by controlling the exposure controller 848, according to the control programs stored in the ROM 843, and controls the fixing temperature of the fixing unit 117, by controlling the fixing control unit 842.

In the first place, in the step S601, the CPU 841 of the printer unit 840 waits for a print-preparation request being notified through serial communication with the CPU 821 of the control unit 820. As is the case with the First Embodiment, when receiving a print-preparation request from the CPU 821 of the control unit 820, the CPU 841 of the printer unit 840 proceeds to the step S602 and then starts the control of fixing temperature, thereby making preparations for starting a job that is anticipated to be implemented thereafter. In this control, the CPU 841 controls for 10 seconds the temperature of the fixing unit 117 with a target temperature of 160° C., by controlling the fixing control unit 842; thereafter, this control is implemented in parallel with the control in the step S603 and other control steps that follow.

In the step S603, the CPU 841 anticipates the start-up time Tp of the scanner motor 849. The start-up time Tp may be a fixed time period, or may appropriately be selected from a table, with start-up times corresponding to temperature, humidity, time period from the previous stop, and the like, being stored in the table, according to the properties of a scanner motor to be utilized. In the Second Embodiment, Tp is set to 1500 msec.

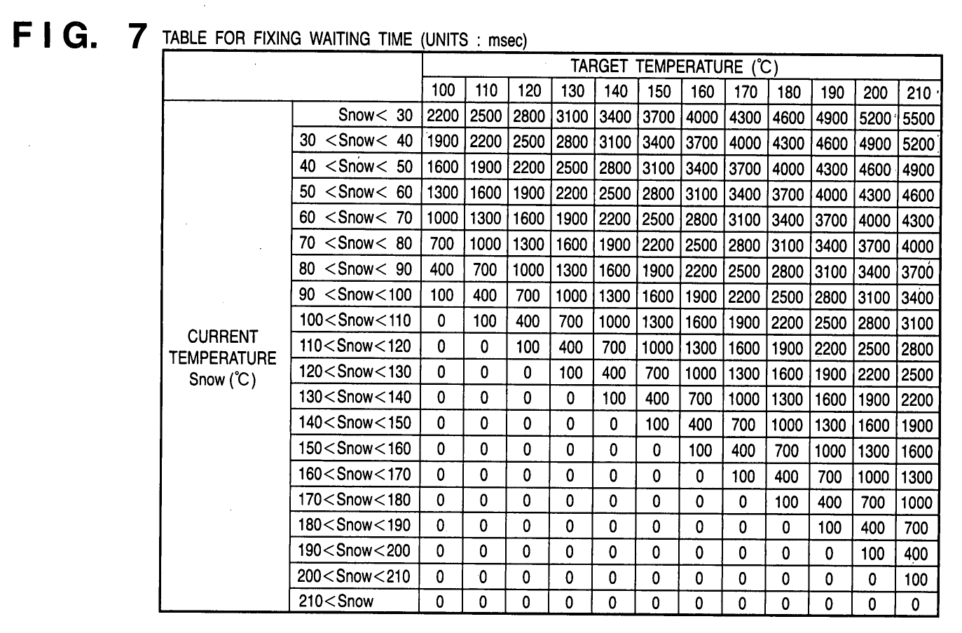

In the step S604, the CPU 841 anticipates a fixing start-up time Tf. The fixing start-up time Tf is selected from a control table, with current temperature of the fixing unit 117, time period from the previous stop, control values corresponding to a target temperature, and the like, being provided as the control table in a program. Also, an arithmetic expression may be employed, by considering Tp a function and utilizing an approximate expression. In the Second Embodiment, it is assumed that a table shown in FIG. 7 is utilized.

In the step S605, the CPU 841 compares the start-up time Tp of the scanner motor with a fixing start-up time Tf, and then returns to the step S604, if the fixing start-up time Tf is larger than Tp; however, if the fixing start-up time Tf is not larger than Tp, the CPU 841 proceeds to the step S606.

For example, in the case where the current temperature of the fixing device is 45° C., it can bee seen from the table shown in FIG. 7 that it takes 3400 msec to reach the target temperature of 160° C.; therefore, the fixing start-up time Tf is 3400 msec. In addition, the start-up time of the scanner motor 849 is 1500 msec, as described above; therefore, even though the scanner motor 849 is activated at this time point, the time of 1900 msec will be a waiting time.

Therefore, in the Second Embodiment, the CPU 841 does not start the driving of the scanner motor 849, but returns to the step S604. Thereafter, the temperature of the fixing device rises; then, in the case where the current temperature of the fixing device is 115° C., it can bee seen from the table shown in FIG. 7 that it takes 1300 msec to reach the target temperature of 160° C., and the fixing start-up time Tf becomes smaller than the start-up time Tp of the scanner motor 849; therefore, the CPU 841 proceeds to the step S606.

In the step S606, the CPU 841 starts the driving of the scanner motor 849 and, in the step S607, clears to “0” the value Tw of a driving-time measuring counter for measuring a driving time for the scanner motor 849. The driving-time measuring counter is configured in such a way as to be counted up every one second, by the CPU clock being counted by a hardware counter built in the CPU 841.

In the step S608, the CPU 841 waits for the notification of a print-start request arriving through serial communication with the control unit 820, within a predetermined time period from the start of the driving of the scanner motor 849. When receiving a print-start request within the predetermined time period (Twmax), the CPU 841 proceeds to the step S611; after implementing the foregoing image-forming operation and finishing image-forming, the CPU 841 returns to the step S601 and the repeats the foregoing processes.

When detecting a key operation through the operation unit 860, or when receiving a printing assignment from an unillustrated external apparatus, the CPU 821 of the control unit 820 issues a print-start request to the CPU 841 of the printer unit 840.

When receiving in the step S608 no notification of a print-start request, the CPU 841 proceeds to the step S609 and then compares the value Tw of the driving-time measuring counter with the maximal driving time Twmax. If the value Tw of the driving-time measuring counter is not larger than the maximal driving time Twmax, the CPU 841 returns to the step S608; if Tw is larger than Twmax, while proceeding to the step S610, the CPU 841 stops the driving of the scanner motor 849, which is print-preparation operation, in order not to unnecessarily drive the scanner motor 849. Thereafter, the CPU 841 returns to the step S601 and then repeats the foregoing processes.

In the Second Embodiment, by setting the foregoing maximal driving time Twmax to 10, the scanner motor 849 is driven for 10 seconds.

As described above, according to the Second Embodiment, in the case where a scanner motor having a short start-up time is utilized, the CPU 841 controls the scanner motor to be activated in such a way that the start-up of the fixing unit is completed at the same time as the start-up of the scanner motor, by, when a key operation is implemented, anticipating the start-up time of the scanner motor and the start-up time of the fixing unit, even in the case where the scanner motor first starts up and waits for the temperature of the fixing unit being raised. Accordingly, regardless of whether or not a finisher is present, a finishing mode, a waiting time in which no image-forming is implemented, and the like, it is possible to optimize the activating timing for a scanner motor, whereby, in the print-preparation operation, the scanner motor is not unnecessarily driven; therefore, prolonging of the lifetime of the scanner motor can be achieved.

In addition, as is the case with the First Embodiment, when it is within a predetermined time period after the opening/closing of the door of the printer unit has occurred, a print-preparation request from the control unit may be neglected.

Moreover, the present invention may be applied either to a system made up of a plurality of apparatuses (e.g., a host computer, an interface device, a reader, a printer, and the like) or to a stand-alone apparatus (e.g., a copy machine, a facsimile machine, or the like).

Furthermore, it goes without saying that the object of the present invention can also be achieved, by providing a system or an apparatus with recording media in which program codes of the software that realizes the functions of the foregoing embodiments are recorded, and by making the computer (CPU or MPU) of the system or the apparatus read out and implement the program codes stored in the recording media.

In this case, the program codes themselves that are read out from the recording media realize the functions of the foregoing embodiment; therefore, the recording media in which the program codes are stored constitute the present invention.

As a storage medium for providing such program codes, for example, a floppy (a registered trademark) disk, a hard disk, an optical disk, a magneto-optical disk, a CD-ROM, a CD-R, a magnetic tape, a nonvolatile memory card, a ROM, and or the like can be employed.

It goes without saying that the present invention includes not only the case where, by making a computer implement the read-out program codes, the functions of the foregoing embodiments are realized, but also the case where, by making an OS (operating system), or the like, operating on the computer implement part of or all of the actual processing, based on the instructions of the program codes, the functions of the foregoing embodiments are realized.

Moreover, it goes without saying that the present invention also includes the case where, by storing the program codes read out from the recording media in a memory equipped in a function-enhancing board inserted into the computer, or in a function-enhancing unit connected to the computer, and then by making a CPU or the like, equipped in the function-enhancing board or the function-enhancing unit, implement part of or all of the actual processing, based on the instructions of the program codes, the functions of the foregoing embodiments are realized.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application Nos. 2004-169090 filed on Jun. 7, 2004 and 2005-154144 filed on May 26, 2005, which are hereby incorporated by reference herein.

1. A method of controlling an image-forming apparatus, comprising:
a determining step of determining whether or not an instruction for an image-forming that differs from an image-forming start instruction is carried out;
an image-forming preparation request generating step of generating an image-forming preparation request, when it is determined in the determining step that the instruction is carried out;
a preparation-operation implementing step of implementing preparation operation in response to occurrence of the preparation request;
a door opening/closing detecting step of detecting opening/closing of a door of the image-forming apparatus; and
a controlling step of prohibiting the preparation operation from being implemented, when the preparation request occurs within a predetermined time period after it has been detected in the door opening/closing detecting step that the door, which had been opened, has been closed.

2. The method according to claim 1, wherein, in the preparation-operation implementing step, a scanner motor for rotating a polygon mirror is driven for a predetermined time period.

3. A method of controlling an image-forming apparatus having a control unit and a printing engine, comprising:
a image-forming preparation request generating step of making the control unit notify the printing engine of an image-forming preparation request, in response to detection of a user operation from which an image-forming start is anticipated;
a preparation-operation implementing step of making the printing engine implement preparation operation in response to reception of the image-forming preparation request from the control unit;
a door opening/closing detecting step of making the printing engine detect opening/closing of a door of the image-forming apparatus; and
a controlling step of making the printing engine prohibit the preparation operation from being implemented, when the image-forming preparation request is received within a predetermined time period after it has been detected in the door opening/closing detecting step that the door, which had been opened, has been closed.

4. The method according to claim 3, wherein, in the preparation-operation implementing step, the printing engine is made to drive for a predetermined time period a scanner motor for rotating a polygon mirror.

5. The method according to claim 3, wherein, in the image-forming preparation request generating step, the control unit is made to generate the image-forming preparation request, in response to detection of opening/closing of a document feeder provided on the image-forming apparatus, or detection of setting a document into the document feeder.

6. The method according to claim 3, wherein, in the image-forming preparation request generating step, the control unit is made to generate the image-forming preparation request, in response to detection of operating a key, other than an image-forming start key, among keys provided on an operation unit of the image-forming apparatus.

7. The method according to claim 3, wherein, in the controlling step, the printing engine is made to prohibit the preparation operation from being implemented, if the image-forming preparation request is received within a predetermined time period after the power for the image-forming apparatus has been turned ON.

8. A method of controlling an image-forming apparatus having a control unit and a printing engine, comprising:
an image-forming preparation request receiving step of receiving an image-forming preparation request that is generated in the control unit, based on anticipation of an image-forming start.
a door opening/closing detecting step of detecting opening/closing of a door of the image-forming apparatus; and
a controlling step of prohibiting preparation operation from being implemented, when the image-forming preparation request is received within a predetermined time period after it has been detected in the door opening/closing detecting step that the door, which had been opened, has been closed, or of permitting preparation operation, when the image-forming preparation request is received after the predetermined time period has elapsed.

9. The method according to claim 8, wherein, when, in the controlling step, implementation of preparation-operation is permitted, a scanner motor for rotating a polygon mirror is driven for a predetermined time period.

10. An image-forming apparatus, comprising:
determination portion which determines whether or not an instruction for an image-forming that differs from an image-forming start instruction is carried out;
image-forming preparation request generating portion which generates an image-forming preparation request, when it is determined by the determination portion that the instruction is carried out;
preparation-operation implementing portion which implements preparation operation in response to occurrence of the preparation request;
door opening/closing detection portion which detects opening/closing of a door of the image-forming apparatus; and
controlling portion which prohibits preparation operation from being implemented by the preparation-operation implementing portion, when the preparation request occurs within a predetermined time period after it has been detected by the door opening/closing detection portion that the door, which had been opened, has been closed.

11. An image-forming apparatus having a control unit and a printing engine, comprising:
the control unit comprising image-forming preparation request generating portion which notifies the printing engine of an image-forming preparation request, in response to detection of a user operation from which an image-forming start is anticipated;
the printing engine comprising:
preparation-operation implementing portion which implements preparation operation, in response to reception of the image-forming preparation request from the control unit;
door opening/closing detection portion which detects opening/closing of a door of the image-forming apparatus; and
controlling portion which makes the preparation-operation implementing portion prohibit the preparation operation from being implemented, when the image-forming preparation request is received within a predetermined time period after it has been detected by the door opening/closing detection portion that the door, which had been opened, has been closed.

12. An image-forming apparatus having a control unit and a printing engine, comprising:
image-forming preparation request receiving portion which receives an image-forming preparation request that is generated in the control unit, in response to anticipation of an image-forming start.
door opening/closing detection portion which detects opening/closing of a door of the image-forming apparatus; and
controlling portion which prohibits preparation operation from being implemented, when the image-forming preparation request is received within a predetermined time period after it has been detected by the door opening/closing detection portion that the door, which had been opened, has been closed, or for permitting preparation operation, when the image-forming preparation request is received after the predetermined time period has elapsed.
